(19) United States
(12) Patent Application Publication
(10) Pub. No.: US 2025/0174170 A1
(43) Pub. Date: May 29, 2025

(54) DISPLAY DEVICE, DATA PROCESSOR AND DATA PROCESSING METHOD

(71) Applicant: LG Display Co., Ltd., Seoul (KR)

(72) Inventor: Gyeong Ho RYU, Paju-si (KR)

(21) Appl. No.: 18/660,032

(22) Filed: May 9, 2024

(30) Foreign Application Priority Data
Nov. 27, 2023 (KR) 10-2023-0166446

(51) Int. Cl. G09G 3/20

(52) U.S. Cl. CPC G09G 3/2092; G09G 2300/0842; G09G 2310/0291; G09G 2310/08; G09G 2330/021

(57) ABSTRACT

Embodiments of the disclosure relate to a display device, a data processor, and a data processing method and, specifically, may provide a display device comprising a display panel including a plurality of subpixels, a memory system configured to process input data in unit of sector, a timing controller configured to control data reading operation and data writing operation for the memory system, and a data processor configured to maintain sector data stored in a first area within a sector and store the input data in a second area within the sector, based on an address of the input data.

### CROSS-REFERENCE TO RELATED APPLICATION

This application claims priority from Korean Patent Application No. 10-2023-0166446, filed on Nov. 27, 2023, which is hereby incorporated by reference for all purposes as if fully set forth herein.

### BACKGROUND

### Technical Field

Embodiments of the disclosure relate to a display device, a data processor and a data processing method, and more specifically, to a display device, a data processor and a data processing method capable of processing data in sectors or less.

### Description of the Related Art

In response to the development of the information society, a variety of demands for image display devices are increasing. In this regard, a range of display devices, such as liquid crystal display (LCD) devices and organic light-emitting display devices, have recently come into widespread use.

Among such display devices, organic light-emitting display devices are advantageous in terms of rapid response rates, high contrast ratios, high emission efficiency, high luminance, wide viewing angles, and the like, since organic light-emitting diodes emitting light by themselves are used therein.

Such an organic light-emitting display device may include organic light-emitting diodes (OLEDs) disposed in a plurality of subpixels arrayed in a display panel, and may control the OLEDs to emit light by controlling current flowing through the OLEDs, thereby displaying an image while controlling the luminance of the subpixels.

These display devices can use flash memory, which has a fixed size of a sector as a basic unit.

### BRIEF SUMMARY

The inventors of the disclosure recognized that when flash memory is used in a display device, there may be a problem if the flash memory is divided by sector and the address is modified in unit of sector for processing data.

The inventors of the disclosure have invented a display device, a data processor and a data processing method capable of processing data in sectors or less.

Embodiments of the disclosure may provide a display device, a data processor and a data processing method capable of processing data in sectors or less by dividing a start address and an end address in unit of sector and processing data in unit of sector or less depending on the locations of the start address and end address.

Embodiments of the disclosure may provide a display device comprising a display panel including a plurality of subpixels, a memory system configured to process input data in unit of sector, a timing controller configured to control data reading operation and data writing operation for the memory system, and a data processor configured to maintain sector data stored in a first area within a sector and store the input data in a second area within the sector, based on an address of the input data

Embodiments of the disclosure provide a data processor incorporated to a memory system processing data in unit of sector, comprising a data input unit configured to receive an input data, an address input unit configured to receive an address of the input data, an address counter configured to determine the first area for maintaining sector data stored in the memory system and the second area for writing the input data in a sector using the address of the input data, a reading buffer configured to transmit the sector data supplied from the memory system, a switching circuit configured to transmit the input data or the sector data according to control of the address counter, and a writing buffer configured to write data transmitted from the switching circuit to the memory system.

Embodiments of the disclosure provide a data processing method of a display device, comprising a step of receiving input data and address, a step of determining location digit and size digit of the address using sector information of a memory system, a step of extracting count information for processing data in unit of sector corresponding to the input data, and a step of processing data in unit of sector using the count information.

According to embodiments of the disclosure, it is possible to process data in sectors or less.

According to embodiments of the disclosure, it is possible to process data in sectors or less by dividing a start address and an end address in unit of sector and processing data in unit of sector or less depending on the locations of the start address and end address.

According to embodiments of the disclosure, it is possible to reduce power consumption and operate with low power by using non-volatile memory such as flash memory.

### DESCRIPTION OF THE SEVERAL VIEWS OF THE DRAWINGS

The above and other objects, features, and advantages of the disclosure will be more clearly understood from the following detailed description, taken in conjunction with the accompanying drawings, in which:

FIG. 1 is a diagram schematically illustrating a display device according to embodiments;

FIG. 2 is an example diagram illustrating a system of the display device according to embodiments;

FIG. 3 is a diagram illustrating the structure of a memory system in a display device according to embodiments;

FIG. 4 is a block diagram illustrating the configuration of a data processor in a display device according to embodiments;

FIG. 5 is a diagram illustrating an example where the start address and end address for writing data are located in the middle of the sector in the display device according to embodiments;

FIGS. 6 to 9 are diagrams illustrating count information generated by an address counter of a data processor for processing input data in a display device according to embodiments;

FIGS. 10 to 12 are diagrams illustrating the status of written data for each sector in a display device according to embodiments;

FIG. 13 is a flowchart of a data processing method according to embodiments.

### DETAILED DESCRIPTION

Hereinafter, some embodiments of the disclosure will be described in detail with reference to example drawings. In the following description of examples or embodiments of the disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the disclosure, detailed descriptions of well-known functions and components incorporated herein will be omitted when it is determined that the description may make the subject matter in some embodiments of the disclosure rather unclear. The terms such as “including,” “having,” “containing,” “constituting” “make up of,” and “formed of” used herein are generally intended to allow other components to be added unless the terms are used with the term “only.” As used herein, singular forms are intended to include plural forms unless the context clearly indicates otherwise.

Terms, such as “first,” “second,” “A,” “B,” “(A),” or “(B)” may be used herein to describe elements of the disclosure. Each of these terms is not used to define essence, order, sequence, or number of elements, etc., but is used merely to distinguish the corresponding element from other elements.

When it is mentioned that a first element “is connected or coupled to,” “contacts or overlaps,” etc., a second element, it should be interpreted that, not only can the first element “be directly connected or coupled to” or “directly contact or overlap” the second element, but a third element can also be “interposed” between the first and second elements, or the first and second elements can “be connected or coupled to,” “contact or overlap,” etc., each other via a fourth element. Here, the second element may be included in at least one of two or more elements that “are connected or coupled to,” “contact or overlap,” etc., each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes, etc., are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can.”

Hereinafter, various embodiments of the disclosure will be described in detail with reference to the accompanying drawings.

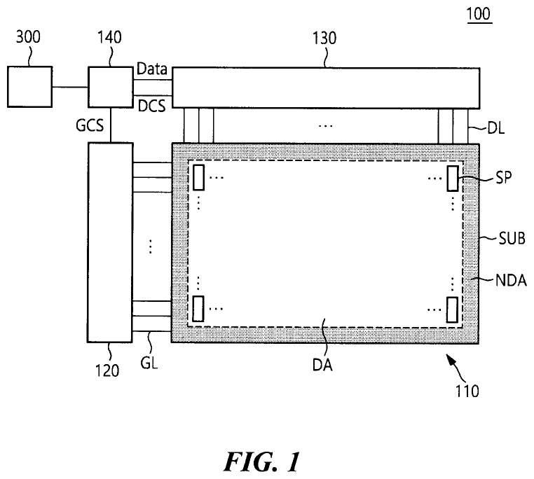

FIG. 1 is a diagram schematically illustrating a display device according to embodiments.

Referring to FIG. 1, a display device 100 according to embodiments may include a display panel 110 and a driving circuit for driving the display panel 110.

The display panel 110 may include a display area DA on which images are displayed and a non-display area NDA on which no images are displayed. The non-display area NDA may also be referred to as a bezel area.

The display panel 110 may include a plurality of subpixels SP to display images. For example, the plurality of subpixels SP may be disposed in the display area DA. In some cases, at least one subpixel SP may be disposed in the non-display area NDA. The at least one subpixel SP disposed in the non-display area NDA is referred to as a dummy subpixel.

The display panel 110 may include a plurality of signal lines to drive the plurality of subpixels SP. For example, the plurality of signal lines may include a plurality of data lines DL and a plurality of gate lines GL. The signal lines may further include other signal lines than the plurality of data lines DL and the plurality of gate lines GL according to the structure of the subpixels SP. For example, the other signal lines may include driving voltage lines, reference voltage lines, and the like.

The plurality of data lines DL may intersect the plurality of gate lines GL. Each of the plurality of data lines DL may be disposed to extend in a first direction. Each of the plurality of gate lines GL may be disposed to extend in a second direction. Here, the first direction may be a column direction, while the second direction may be a row direction. In this specification, the column direction and the row direction are relative terms. In an example, the column direction may be a vertical direction, while the row direction may be a horizontal direction. In another example, the column direction may be a horizontal direction, while the row direction may be a vertical direction.

The driving circuit may include a data driving circuit 130 to drive the plurality of data lines DL and a gate driving circuit 120 to drive the plurality of gate lines GL. The driving circuit may further include a timing controller 140 to control the data driving circuit 130 and the gate driving circuit 120.

The data driving circuit 130 is a circuit to drive the plurality of data lines DL, and may output data signals (also referred to as data voltages) corresponding to an image signal to the plurality of data lines DL. The gate driving circuit 120 is a circuit to drive the plurality of gate lines GL, and may generate gate signals and output the gate signals to the plurality of gate lines GL. The gate signals may include one or more scan signals and an emission signal.

The timing controller 140 may start scanning in timing set for respective frames and control data driving at appropriate points in time in response to the scanning. The timing controller 140 may convert image data input from an external source into image data Data having a data signal format readable by the data driving circuit 130 and output the image data Data to the data driving circuit 130.

The timing controller 140 may receive display drive control signals together with the input image data from a host system 300. For example, the display drive control signals may include a vertical synchronization signal, a horizontal synchronization signal, an input data enable signal, a clock signal, and the like.

The timing controller 140 may generate a data drive control signal DCS and a gate drive control signal GCS on the basis of the display drive control signals input from the host system 300. The timing controller 140 may control the drive operation and the drive timing of the data driving circuit 130 by supplying the data drive control signal DCS to the data driving circuit 130. The timing controller 140 may control the drive operation and the drive timing of the gate driving circuit 120 by supplying the gate drive control signal GCS to the gate driving circuit 120.

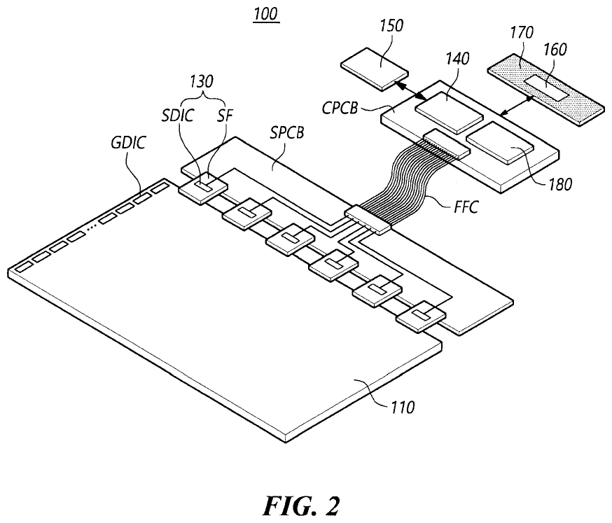

The data driving circuit 130 may include one or more source driving integrated circuits SDIC (see FIG. 2). Each of the source driving integrated circuits SDIC may include a shift register, a latch circuit, a digital-to-analog converter (DAC), an output buffer, and the like. Each of the source driving integrated circuits SDIC may further include an analog-to-digital converter (ADC).

For example, each of the source driving integrated circuits SDIC may be connected to the display panel 110 using a tape-automated bonding (TAB) structure, may be connected to a bonding pad of the display panel 110 using a chip-on-glass (COG) structure or a chip-on-panel COP structure, or may be implemented using a chip-on-film (COF) structure connected to the display panel 110.

The gate driving circuit 120 may output a gate signal having a turn-on-level voltage or a gate signal having a turn-off-level voltage under the control of the timing controller 140. The gate driving circuit 120 may sequentially drive the plurality of gate lines GL by sequentially supplying the gate signal having a turn-on-level voltage to the plurality of gate lines GL.

For example, the display device 100 with a resolution of 2,160×3,840 may include four subpixels SP comprised of white subpixel W, red subpixel R, green subpixel G and blue subpixel B. In this case, a total of 3,840×4=15,360 data lines DL may be arranged by each 3,840 data lines DL connected to 4 subpixels WRGB and 2,160 gate lines GL. Additionally, subpixels SP may be formed in areas crossed by the gate line GL and data line DL, respectively.

The gate driving circuit 120 is controlled by the timing controller 140, and controls the driving timing for the plurality of subpixels SP by supplying sequentially gate signals to a plurality of gate lines GL arranged on the display panel 110.

In the display device 100 with a resolution of 2,160×3,840, an operation of sequentially supplying gate signals from the first gate line to the 2,160th gate line for 2,160 gate lines GL may be called 2,160 phase driving operation. Alternatively, as of an operation of sequentially supplying gate signals from the first gate line to the fourth gate line and then sequentially supplying the gate signals from the fifth gate line to the eighth gate line, the operation of sequentially supplying gate signals in units of four gate lines GL may be called 4-phase driving operation. In other words, the operation of sequentially supplying the gate signal in units of the N gate lines GL may be referred to as N-phase driving operation.

The gate driving circuit 120 may include one or more gate driving integrated circuits GDIC (scc FIG. 2).

The gate driving circuit 120 may be connected to the display panel 110 using a TAB structure, connected to bonding pads of the display panel 110 using a COG structure or a COP structure, or connected to the display panel 110 using a COF structure. Alternatively, the gate driving circuit 120 may be implemented using a gate-in-panel (GIP) structure provided in the non-display area NDA of the display panel 110. The gate driving circuit 120 may be disposed on a circuit board or connected to the circuit board. That is, when the gate driving circuit 120 has a GIP structure, the gate driving circuit 120 may be disposed in the non-display area NDA. When the gate driving circuit 120 has a COG structure, a COF structure, or the like, the gate driving circuit 120 may be connected to the circuit board.

In addition, at least one driving circuit of the data driving circuit 130 and the gate driving circuit 120 may be disposed in the display area DA. For example, at least one driving circuit of the data driving circuit 130 and the gate driving circuit 120 may be disposed to not overlap the subpixels SP or disposed such that a portion or the entirety thereof overlaps the subpixels SP.

The data drive data driving circuit 130 may be connected to one side (e.g., the upper side or the lower side) of the display panel 110. The data drive data driving circuit 130 may be connected to both sides (e.g., the upper side and the lower side) of the display panel 110 or two or more sides of four sides of the display panel 110, depending on the driving method, the design of the display panel, or the like.

The gate driving circuit 120 may be connected to one side (e.g., the left side or the right side) of the display panel 110. The gate driving circuit 120 may be connected to both sides (e.g., the left side and the right side) of the display panel 110 or two or more sides of four sides of the display panel 110, depending on the driving method, the design of the display panel, or the like.

The timing controller 140 may be provided as a component separate from the data driving circuit 130 or may be combined with the data driving circuit 130 to form an integrated circuit (IC). The timing controller 140 may be a timing controller used in typical display technology, may be a control device including a timing controller and performing other control functions, or may be a circuit in the control device. The timing controller 140 may be implemented as any of a variety of circuits or electronic components such as an IC, a field programmable gate array (FPGA), an application specific integrated circuit (ASIC), or a processor.

The timing controller 140 may be mounted on a printed circuit board (PCB), a flexible printed circuit (FPC), or the like, and may be electrically connected to the data driving circuit 130 and the gate driving circuit 120 through the PCB, the FPC, or the like. The timing controller 140 may transmit and receive signals to and from the data driving circuit 130 according to predetermined one or more interfaces. Here, for example, the interfaces may include a low voltage differential signaling (LVDS) interface, an embedded panel interface (EPI), a serial peripheral (SP) interface, and the like.

The display device 100 according to embodiments may be a self-light-emitting display device in which the display panel 110 emits light by itself. When the display device 100 according to embodiments is a self-light-emitting display device, each of the plurality of subpixels SP may include a light-emitting element. In an example, the display device 100 according to embodiments may be an organic light-emitting display device in which light-emitting elements are organic light-emitting diodes (OLEDs). In another example, the display device 100 according to embodiments may be an inorganic light-emitting display device in which light-emitting elements are light-emitting diodes (LEDs) based on an inorganic material. In another example, the display device 100 according to embodiments may be a quantum dot display device in which light-emitting elements are quantum dots serving as self-light-emitting semiconductor crystals

FIG. 2 is an example diagram illustrating a system of the display device according to embodiments.

Referring to FIG. 2, the display device 100 according to embodiments is an example in which the data driving circuit 130 is implemented using a COF structure from among a variety of structures such as TAB, COG, and COF structures, and the gate driving circuit 120 is implemented using a GIP structure from among a variety of structures such as TAB, COG, COF, and GIP structures.

When the gate driving circuit 120 has the GIP structure, the plurality of gate driving integrated circuits GDIC of the gate driving circuit 120 may be directly formed in the non-display area of the display panel 110. Here, the gate driving integrated circuits GDIC may be provided with a variety of signals (e.g., a clock, a gate high signal, and a gate low signal) required for generation of scan signals through gate driving-related signal lines disposed in the non-display area.

In the same manner, the source driving integrated circuits SDIC of the data driving circuit 130 may be mounted on source films SF, respectively. One side of each of the source films SF may be electrically connected to the display panel 110. In addition, conductive lines electrically connecting the source driving integrated circuits SDIC to the display panel 110 may be disposed on the top portions of the source films SF.

The display device 100 may include at least one source printed circuit board SPCB and a control printed circuit board CPCB for circuit connection of the plurality of source driving integrated circuits SDIC to other devices. Here, control components and a variety of electrical devices may be mounted on the control printed circuit board CPCB.

Here, the other sides of the source films SF on which the source driving integrated circuits SDIC are mounted may be connected to the source printed circuit board SPCB. That is, each of the source films SF on which the source driving integrated circuits SDIC are mounted may be configured such that one side thereof is electrically connected to the display panel 110 and the other side thereof is electrically connected to the source printed circuit board SPCB.

The timing controller 140 and a power management circuit 180 may be mounted on the control printed circuit board CPCB. The timing controller 140 may control the operation of the data driving circuit 130 and the gate driving circuit 120. The power management circuit 180 may supply a driving voltage or current to the display panel 110, the data driving circuit 130, the gate driving circuit 120, and the like and may control the supplied voltage or current.

The source printed circuit board SPCB and the control printed circuit board CPCB may be circuit-connected to each other through at least one connecting member. The connecting member may be, for example, a flexible flat cable FFC, a flexible printed circuit (FPC), or the like. In addition, the source printed circuit board SPCB and the control printed circuit board CPCB may be integrated into a single printed circuit board (PCB).

The display device 100 may further include a set board 170 electrically connected to the control printed circuit board CPCB. Here, the set board 170 may also be referred to as a power board. The set board 170 may be provided with a main power management circuit 160 to manage the overall power of the display device 100. The main power management circuit 160 may work in concert with the power management circuit 180.

In the display device 100 having the above-described configuration, a driving voltage is generated by the set board 170 and is transferred to the power management circuit 180 in the control printed circuit board CPCB. The power management circuit 180 transfers the driving voltage, required for display driving or characteristic value sensing, to the source printed circuit board SPCB through the flexible printed circuit or the flexible flat cable FFC. The driving voltage transferred to the source printed circuit board SPCB is supplied through the driving integrated circuits SDIC in order to light or sense a specific subpixel SP in the display panel 110.

Here, each of the subpixels SP arrayed in the display panel 110 of the display device 100 may include a light-emitting element and circuit elements, such as a driving transistor, for driving the light-emitting element.

The type and number of the circuit elements provided in each of the subpixels SP may be determined variously depending on functions to be provided, designs, and the like

Additionally, the display device 100 of the present disclosure may include a memory system 150 for storing image data transmitted from the host system 300 or data calculated by the timing controller 140.

The memory system 150 may include non-volatile memory, such as flash memory, resistive random access memory (RRAM), etc.

When the memory system 150 is non-volatile memory such as flash memory, the basic unit for accessing data stored in the memory system 150 may be defined as a sector, which can be determined according to the structure of the memory system 150.

At this time, the sector corresponding to the basic unit of flash memory can have a size of 1 KB, 2 KB, or 4 KB, and two or more consecutive sectors can be composed of one block.

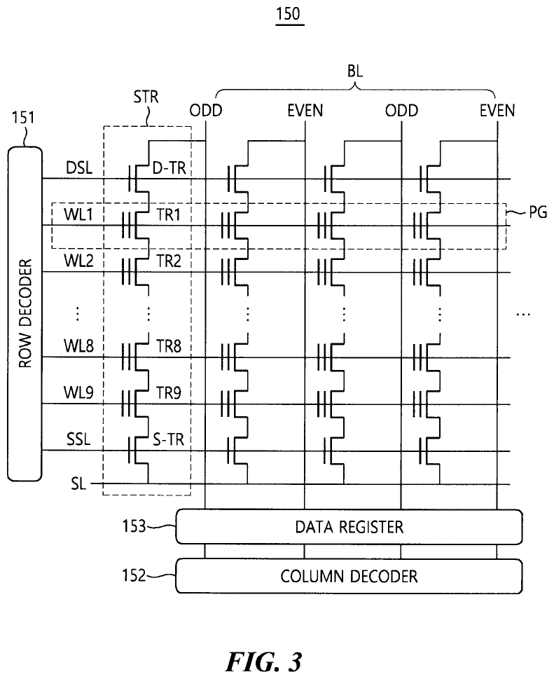

FIG. 3 is a diagram illustrating the structure of a memory system in a display device according to embodiments.

Referring to FIG. 3, the memory device 110 of the display device 100 according to embodiments may have a core area in which memory cells are arranged, and an auxiliary area, which is the remaining area other than the core area, to support the operations of the memory cell array.

The core area may include pages PG and strings STR. In this core area, a plurality of word lines WL1-WL9 and a plurality of bit lines BL are arranged to intersect.

The plurality of word lines WL1-WL9 may be connected to a row decoder 151, and the plurality of bit lines BL may be connected to a column decoder 152. A data register 153, which corresponds to a read/write circuit, may exist between the plurality of bit lines BL and the column decoder 152.

The plurality of word lines WL1-WL9 may correspond to a plurality of pages PG. For example, each of the plurality of word lines WL1-WL9 may correspond to one page PG. On the other hand, when each of the plurality of word lines WL1-WL9 has a large size, each of the plurality of word lines WL1-WL9 may correspond to at least two (e.g., two or four) pages PG. Each page PG may be the smallest unit in a write operation and a read operation, and all memory cells in the same page PG may perform simultaneous operations when conducting a write operation and a read operation.

The plurality of bit lines BL may be connected to the column decoder 152. The plurality of bit lines BL may be divided into odd-numbered bit lines and even-numbered bit lines.

In accessing a memory cell MC, the row decoder 151 and the column decoder 152 are used to designate a target memory cell based on the address. Designating a target memory cell means accessing to write data in the memory cell at the intersection of the word lines WL1-WL9 connected to the row decoder 151 and the bit lines BL connected to the column decoder 152 or to read the stored data.

The data register 153 plays an important role because all data processing operations by the memory system 150, including write and read operations, occurs via the data register 153. If data processing operation by the data register 153 is delayed, all of the other areas need to wait until the data register 153 finishes the data processing operation. Also, degradation of the performance of the data register 153 may lead to degradation of the overall performance of the memory system 150.

In one memory cell string STR, a plurality of transistors TR1-TR9 may be connected to the plurality of word lines WL1-WL9, respectively. The areas of the multiple transistors TR1-TR9 correspond to memory cells.

The plurality of word lines WL1-WL9 may include two outermost word lines WL1, WL9. A first selection line DSL may be additionally arranged outside the first outermost word line WL1 closer to the data register 153 among two outermost word lines WL1, WL9. A second selection line SSL may be additionally arranged outside the other second outermost word line WL9 among two outermost word lines WL1, WL9.

The first selection transistor D-TR, which is controlled to turn on/off by the first selection line DSL, has a gate electrode connected to the first selection line DSL, but includes no floating gate. The second selection transistor S-TR, which is controlled to turn on/off by the second selection line SSL, has a gate electrode connected to the second selection line SSL, but includes no floating gate.

The first selection transistor D-TR is used as a switch circuit that connects the corresponding string STR to the data register 153. The second selection transistor S-TR is used as a switch circuit that connects the corresponding string STR to the source line SL. That is, the first selection transistor D-TR and the second selection transistor S-TR may be used to enable or disable the corresponding string STR at both ends of the string STR.

During a data writing operation, the memory system 150 may fill the target memory cell of the bit line BL to be written with electrons. Therefore, the memory system 150 applies a predetermined turn-on voltage Vcc to the gate electrode of the first selection transistor D-TR, thereby turning on the first selection transistor D-TR, and applies a predetermined turn-off voltage (e.g., 0V) to the gate electrode of the second selection transistor S-TR, thereby turning off the second selection transistor S-TR.

The memory system 150 turns on both of the first selection transistors D-TR and the second selection transistor S-TR during a read operation or a verification operation. Accordingly, an electric current may flow through the corresponding string STR and drain to the source line SL corresponding to the ground, such that the voltage level of the bit line BL may be measured. However, during a read operation, there may be a time difference in the turn on/off timing between the first selection transistor D-TR and the second selection transistor S-TR.

The memory system 150 may apply a predetermined voltage (e.g., +20V) to the substrate through a source line SL during an erasure operation. The memory system 150 may allow both the first selection transistor D-TR and the second selection transistor S-TR to float with infinite resistance during an erasure operation. As a result, the role of the first selection transistor D-TR and the second selection transistor S-TR is eliminated, and electrons due to the potential difference only between the floating gate and the substrate can operate.

Meanwhile, EEPROM (Electrically Erasable PROM) can read or write data in units of bytes while mounted on a printed circuit board. However, when writing data in EEPROM, a time delay of several ms or more is required for each byte, so it is not suitable for storing large amounts of data at high speed.

In particular, as the resolution of the display device 100 increases, the need to use flash memory in the memory system 150 increases in situations where large amounts of data are to be processed at high speed.

Flash memory can read data in bytes. However, it is difficult to write data in real time because the flash memory can only be performed in sectors while writing data.

In this way, since flash memory uses sectors as the basic unit, there is a problem when image data is written in sectors, and address is corrected for processing data according to sectors when using flash memory in the display device 100.

The display device 100 of the present disclosure uses flash memory but allows data to be written in sectors or less, thereby improving the efficiency of using flash memory and reducing costs.

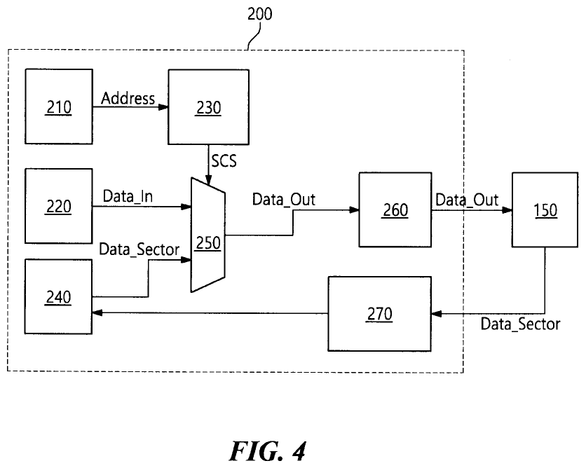

FIG. 4 is a block diagram illustrating the configuration of a data processor in a display device according to embodiments.

Referring to FIG. 4, the display device 100 according to embodiments may include a data processor 200 capable of writing data in sectors or less.

The data processor 200 of the present disclosure may be implemented in the form of an integrated circuit within the timing controller 140, or may be implemented as a separate circuit on a control printed circuit board.

The data processor 200 may include an address input unit 210, a data input unit 220, an address counter 230, a reading buffer 240, a switching circuit 250, a writing buffer 260, and a concatenator 270.

The data input unit 220 is a part where data to be written in the memory system 150 is supplied.

The address input unit 210 is a part where the address of data to be written in the memory system 150 is supplied. The address at which data is written may include the start address and end address of the input data Data_In.

When using flash memory in the memory system 150, there is a problem that data had to be written in sectors (for example, 4 KB). The display device 100 of the present disclosure allows data to be written in the area between the start address and the end address even when the start address and end address for writing data are located in the middle of the sector.

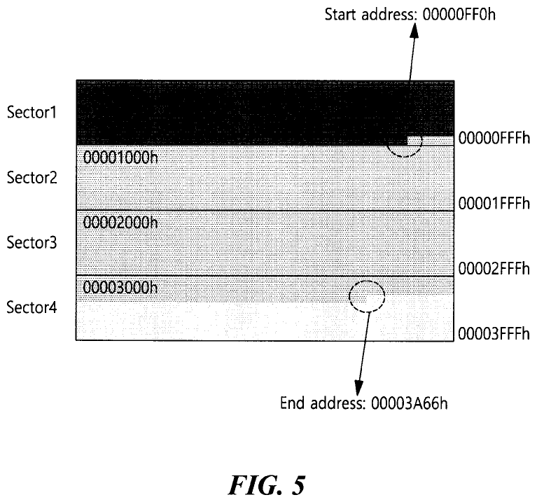

FIG. 5 is a diagram illustrating an example where the start address and end address for writing data are located in the middle of the sector in the display device according to embodiments.

Referring to FIG. 5, the memory system 150 in the display device 100 according to embodiments may be a flash memory divided into a plurality of sectors.

For example, the memory system 150 may be composed of a plurality of sectors with 4 KB as a basic unit. In this case, the memory system 150 may store data in a sector. Here, a first sector Sector1 to a fourth sector Sector4 is shown as an example.

If each sector of the memory system 150 has a size of 4 KB, each sector may have an address interval of 2\hat{ }12. When the address is expressed in hexadecimal, the size of 4 KB corresponds to the lower 3 digits. Therefore, in the case of a hexadecimal address, the lower 3 digits correspond to a sector size of 4 KB and can be called a size digit.

For example, the first sector Sector1 may be assigned an address from 00000000h to 00000FFFh, and the second sector Sector2 may be assigned an address from 00001000h to 00001FFFh. Additionally, the third sector Sector3 may be assigned addresses from 00002000h to 00002FFFh, and the fourth sector Sector4 may be assigned addresses from 00003000h to 00003FFFh. Here, ‘h’ at the end of the 8-digit address means hexadecimal.

When one sector has a size of 4 KB, the lower 3 digits indicate the size of the sector, so if the upper 5 digits of the 8-digit address are the same, they indicate the same sector. Therefore, whether the address belongs to the same sector can be determined by whether the upper 5 digits are the same. Therefore, in the case of a hexadecimal address, the upper 5 digits indicate the location of the address and can be called location digits.

On the other hand, if the size of the sector changes, the upper digit for determining the same sector among the 8-digit addresses will be changed.

Additionally, if the address is expressed in hexadecimal, it may be difficult to determine the sector size of 2 KB or 1 KB as the digits of the address. Therefore, the address expressed in hexadecimal can be converted to binary and the lower digit corresponding to the size of the sector and the location digit corresponding to the location of the address can be extracted and compared.

In this state, data can be written from the rear part of the first sector Sector1 to the front part of the fourth sector Sector4. For example, the start address of the input data Data_In may be 00000FF0h located inside the first sector Sector1, and the end address may be 00003A66h located inside the fourth sector Sector4.

In this way, when the start address of the input data Data_In is located inside the first sector Sector1 and the end address of the input data Data_In is located inside the fourth sector Sector4, the input data Data_In may be written in the entire area of the second sector Sector2 and the third sector Sector3.

For first sector Sector1, while maintaining the stored sector data Data_Sector from the starting point 00000000h of the first sector Sector1 to just previous point 00000FEFh of the start address 00000FF0h of the input data Data_In, input data Data_In can be written from the start address 00000FF0h to the end point 00000FFFh of the first sector Sector1.

In addition, for the fourth sector Sector4, the input data Data_In may be written from the start point 00003000h of the fourth sector Sector4 to the end address 00003A66h of the input data Data_In, while maintaining the sector data Data_Sector in the fourth sector Sector4 from just next point 00003A67h of the end address 00003A66h of input data Data_In to the end point 00003FFFh of the fourth sector Sector4.

For this purpose, the address counter 230 may determine the operation of maintaining sector data Data_Sector or writing input data Data_In in each sector of the memory system 150 using the start address and end address of the input data Data_In.

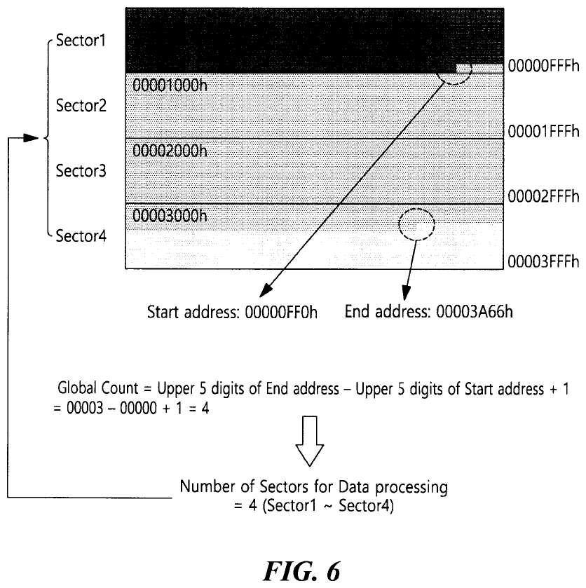

FIGS. 6 to 9 are diagrams illustrating count information generated by an address counter of a data processor for processing input data in a display device according to embodiments.

In the display device 100 according to embodiments, the address counter 230 of the data processor 200 may generate count information for processing data by using the addresses (start address and end address) of the input data Data_In and the sector address.

Firstly referring to FIG. 6, the address counter 230 of the data processor 200 in the display device 100 according to embodiments may determine the number of sectors for processing data by comparing the location digit of the start address and the end address for the input data Data_In. Here, this is called ‘global count.’

The global count may be determined by the difference between the location digit of the end address and the location digit of the start address. For example, in the case of flash memory with a sector size of 4 KB, the locations of the start address and the end address may be determined through the upper 5 digits, respectively.

If the start address is 00000FF0h and the end address is 00003A66h, the start address is located in the first sector Sector1 corresponding to the upper 5 digits 00000, and the end address is located in the fourth sector Sector4 corresponding to the upper 5 digits 00003. Therefore, the number of sectors Sector1˜Sector4 for processing data becomes 4 by adding 1 to the difference between the upper 5 digits of the end address 00003 and the upper 5 digits of the start address 00000.

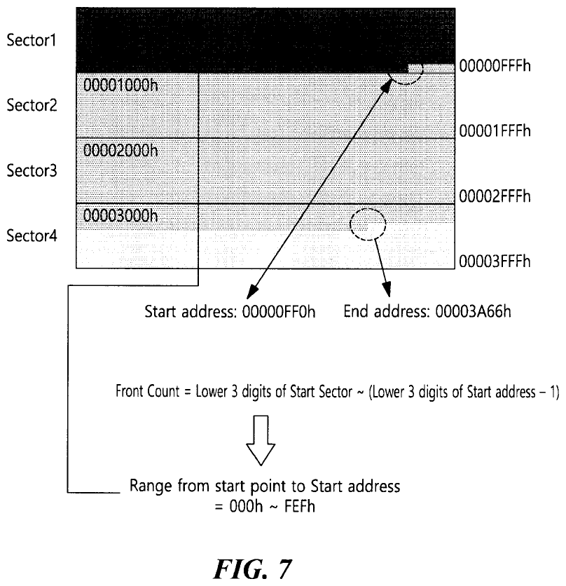

Next, referring to FIG. 7, the address counter 230 of the data processor 200 in the display device 100 according to embodiments may determine the range between the start point of the sector and the start address by comparing a size digit of the start address for the input data Data_In with the start point of the sector. Here, this is called ‘front count.’

The front count may be determined using the size digit of the start address and the starting point of the sector where the start address is located. For example, in the case of a flash memory with a sector size of 4 KB, the sector size may correspond to the lower 3 digits of the start address and the end address. In other words, each of the lower 3 digits of the start address and end address has a value between the start point and the end point in one sector.

Therefore, the distance from the size digit of the start address (e.g., FFFh) to the start point 000h of a sector (e.g., the first sector) where the start address is located represents the range 000h˜FEFh between the start point and the start address in the first sector Sector1.

Since the range indicated by the front count corresponds to an area in which input data Data_In is not written, the sector data Data_Sector stored in the memory system 150 may be maintained as is during the data processing process.

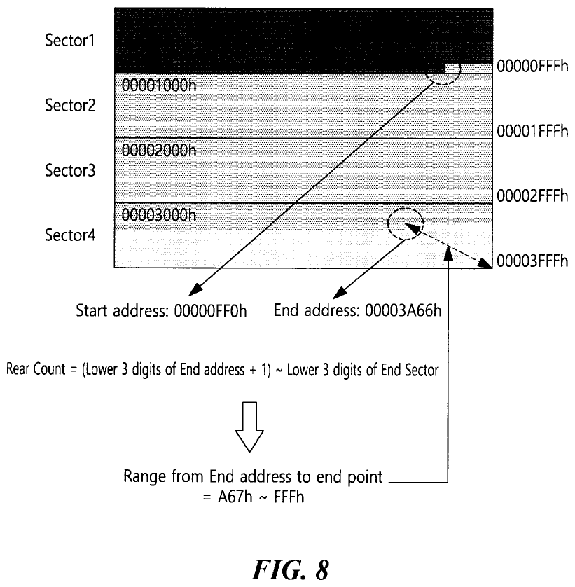

Next, referring to FIG. 8, the address counter 230 of the data processor 200 in the display device 100 according to embodiments may determine the range between the end address and the end point of the sector by comparing the size digit of the end address for the input data Data_In and the end point of the sector. Here, this is called ‘rear count.’

The rear count may be determined by the difference between the size digit of the end address and the end point of the sector where the end address is located. For example, in the case of a flash memory with a sector size of 4 KB, the sector size may correspond to the lower 3 digits of the start address and the end address. In other words, each of the lower 3 digits of the start address and end address has a value between the start point and the end point in one sector.

Therefore, the distance from the size digit (e.g., A66h) of the end address and the end point FFFh of a sector (e.g., the fourth sector) in the fourth sector where the end address is located represents the range A67h˜FFFh between the end point of the fourth sector Sector4 and the end address.

Since the range indicated by the rear count corresponds to an area in which input data Data_In is not written, the sector data Data_Sector stored in the memory system 150 can be maintained as is during the data processing process.

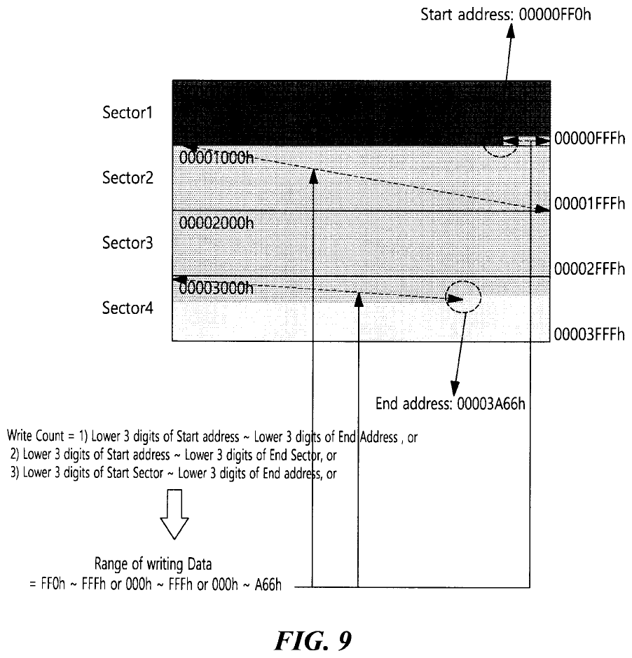

Next, referring to FIG. 9, the address counter 230 of the data processor 200 in the display device 100 according to embodiments may determine the range for writing input data Data_In by using the size digit of the start address or end address for the input data Data_In. Here, this is called ‘write count.’

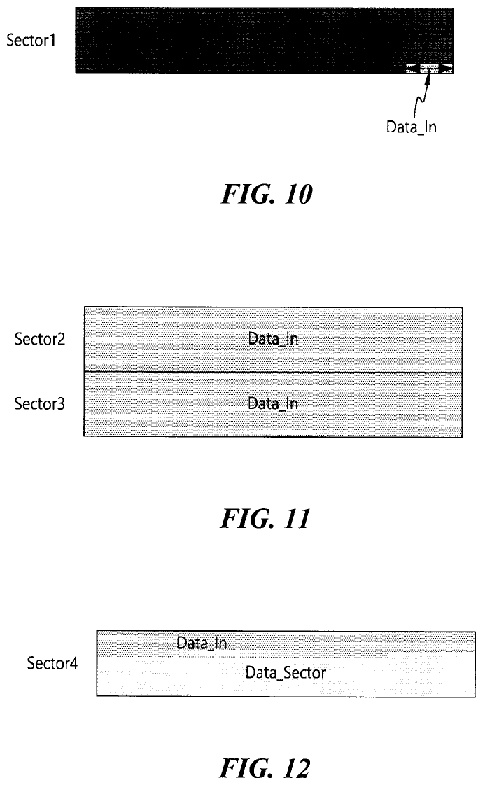

FIGS. 10 to 12 are diagrams illustrating the status of written data for each sector in a display device according to embodiments.

The write count may vary depending on the location of the start address or end address. For example, if the input data Data_In has a start address located in the first sector Sector1 and an end address located in the fourth sector Sector4, the write count may be determined in the first sector Sector1, the second sector Sector2, the third sector Sector3, and the fourth sector Sector4 in different ways.

In the case of flash memory with a sector size of 4 KB, the sector size may correspond to the lower 3 digits of the start address and the end address. In other words, each of the lower 3 digits of the start address and end address has a value between the start point and an end point in one sector.

For the first sector Sector1, the distance 000h˜FEFh between the size digit FEFh of the start address and the starting point 000h of the first sector correspond to the front count, and the other area FF0h˜FFFh excluding the front count corresponds to the write count in the first sector Sector1. Therefore, as shown in FIG. 10, the sector data Data_Sector stored in the memory system 150 may be maintained in the front count 000h˜FEFh, and the input data Data_In may be written in the write count FF0h˜FFFh excluding the front count.

In the second sector Sector2 and the third sector Sector3, the entire area 000h˜FFFh correspond to the range of the write count. Therefore, as shown in FIG. 11, input data Data_In may be written in the entire area 000h˜FFFh of the second sector Sector2 and the third sector Sector3.

In the fourth sector Sector4, the distance A67h˜FFFh between the size digit of the end address A66h and the end point FFFh of the fourth sector Sector4 corresponds to the rear count, and the other area rear 000h˜A66h excluding the rear count corresponds to the write count. Therefore, as shown in FIG. 12, the sector data Data_Sector stored in the memory system 150 may be maintained in the rear count A67h˜FFFh, and the input data Data_In may be written in the write count 000h˜A66h excluding the rear count.

In this way, the range indicated by the write count corresponds to the area in which input data Data_In is written. Therefore, during the data processing process, the sector data Data_Sector stored in the memory system 150 may be deleted and the input data Data_In supplied through the data input unit 220 may be written in the write count.

The address count 230 may generate a switching control signal SCS that controls the switching circuit 250 using the global count, front count, rear count, and write count.

The switching circuit 250 may select input data Data_In supplied through the data input unit 220 or sector data Data_Sector supplied through the reading buffer 240 and generate output data Data_Out. The switching circuit 250 may be a multiplexer.

Meanwhile, the sector data Data_Sector may be extracted in unit of sector from the memory system 150, combined through the concatenator 270, and transmitted to the reading buffer 240.

The output data Data_Out may be written to the memory system 150 in unit of sector through the writing buffer 260.

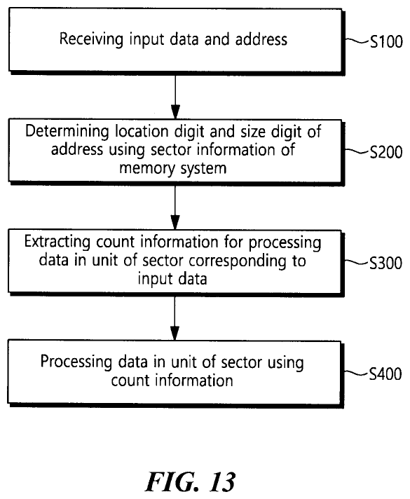

FIG. 13 is a flowchart of a data processing method according to embodiments.

Referring to FIG. 13, the data processing method according to embodiments may include a step S100 of receiving input data and address, a step S200 of determining location digit and size digit of the address using sector information of the memory system, a step S300 of extracting count information for processing data in unit of sector corresponding to the input data, and a step S400 of processing data in unit of sector using the count information.

The step S100 of receiving input data and address is a process of receiving information about the data to be written to the memory system and the address where the data is to be written.

The address may include a start address and an end address, and the address may be expressed in hexadecimal.

The step S200 of determining location digit and size digit of the address using sector information of the memory system is a process of dividing the digit of the address into a location digit and a size digit based on sector information, which is the basic unit for storing data in the memory system.

For example, if the address is expressed with 8 digits in hexadecimal and the sector, which is the basic unit of the memory system, is 4 KB, the lower 3 digits of the address may correspond to the size digit indicating the size of the sector, and the upper 5 digits may correspond to the location digit indicating the location of the address.

At this time, the location digit and size digit may be changed in various ways depending on how the address is expressed and the size of the sector. In order to distinguish the digits corresponding to the size of the sector, the address may also be changed to binary number.

The step S300 of extracting count information for processing data in unit of sector corresponding to the input data is a process of calculating count information for writing input data in each sector using address and sector information. At this time, the count information may include a global count indicating the number of sectors for processing data, a front count indicating a range between the start point of the sector and the start address, a rear count indicating a range between the end address and the end point of the sector, and a write count indicating the range for writing input data Data_In.

The step S400 of processing data in unit of sector using the count information is a process of maintaining sector data in some area or writing input data at least some area for each sector related to input data using the global count, the front count, the rear count, and the write count.

In this way, according to the data processing method of the present disclosure, data can be written in unit of sector or less even when using a flash memory in which data is written in fixed unit of sector. Therefore, it is possible to improve data processing performance and reduce memory costs.

The foregoing embodiments are briefly described below.

An embodiment of present disclosure may provide a display device comprising a display panel including a plurality of subpixels, a memory system configured to process input data in unit of sector, a timing controller configured to control data reading operation and data writing operation for the memory system, and a data processor configured to maintain sector data stored in a first area within a sector and store the input data in a second area within the sector, based on an address of the input data.

The memory system includes a flash memory.

The sector has a size of 4 KB.

The address of the input data includes a location digit corresponding to location of the sector and a size digit corresponding to size of the sector.

The location digit is upper 5 digits and the size digit is lower 3 digits when the address of the input data consists of 8 hexadecimal digits.

The data processor includes a data input unit configured to receive the input data, an address input unit configured to receive the address of the input data, an address counter configured to determine the first area and the second area using the address of the input data, a reading buffer configured to transmit the sector data supplied from the memory system, a switching circuit configured to transmit the input data or the sector data according to control of the address counter, and a writing buffer configured to write data transmitted from the switching circuit to the memory system.

The data processor further includes a concatenator configured to combine the sector data in unit of sector extracted from the memory system and transmit it to the reading buffer.

The address counter generates a global count indicating a number of sectors for processing data by comparing a start address and an end address of the input data, a front count indicating a range between a starting point of the sector and the start address, a rear count indicating a range between the end address and an end point of the sector, and a write count indicating the second area.

The front count and the rear count indicate the first area.

The data processor is disposed within the timing controller.

An embodiment of the present disclosure may provide a data processor incorporated to a memory system processing data in unit of sector, comprising a data input unit configured to receive an input data, an address input unit configured to receive an address of the input data, an address counter configured to determine the first area for maintaining sector data stored in the memory system and the second area for writing the input data in a sector using the address of the input data, a reading buffer configured to transmit the sector data supplied from the memory system, a switching circuit configured to transmit the input data or the sector data according to control of the address counter, and a writing buffer configured to write data transmitted from the switching circuit to the memory system.

An embodiment of the present disclosure may provide a data processing method of a display device, comprising a step of receiving input data and address, a step of determining location digit and size digit of the address using sector information of a memory system, a step of extracting count information for processing data in unit of sector corresponding to the input data, and a step of processing data in unit of sector using the count information.

The count information includes a global count indicating a number of sectors for processing data by comparing a start address and an end address of the input data, a front count indicating a range between a starting point of a sector and the start address, a rear count indicating a range between the end address and an end point of the sector, and a write count indicating an area for writing the input data.

The front count and the rear count indicate an area for maintaining data in the sector.

The data processing method further comprises a step of converting the address to binary number.

The above description has been presented to enable any person skilled in the art to make and use the technical idea of the disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the disclosure. The above description and the accompanying drawings provide an example of the technical idea of the disclosure for illustrative purposes only. That is, the disclosed embodiments are intended to illustrate the scope of the technical idea of the disclosure.

The various embodiments described above can be combined to provide further embodiments. Aspects of the embodiments can be modified, if necessary to employ concepts of the various embodiments to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A display device, comprising:
a display panel including a plurality of subpixels;
a memory system configured to process input data in unit of sector;
a timing controller configured to control data reading operation and data writing operation of the memory system; and
a data processor configured to maintain sector data stored in a first area within a sector and store the input data in a second area within the sector, based on an address of the input data.

2. The display device of claim 1, wherein the memory system includes a flash memory.

3. The display device of claim 1, wherein the sector has a size of 4 KB.

4. The display device of claim 1, wherein the address of the input data includes:
a location digit corresponding to a location of the sector; and
a size digit corresponding to a size of the sector.

5. The display device of claim 4, wherein the address of the input data consists of 8 hexadecimal digits, the location digit is upper 5 digits of the 8 hexadecimal digits, and the size digit is lower 3 digits of the 8 hexadecimal digits.

6. The display device of claim 1, wherein the data processor includes:
a data input unit configured to receive the input data;
an address input unit configured to receive the address of the input data;
an address counter configured to determine the first area and the second area using the address of the input data;
a reading buffer configured to transmit the sector data supplied from the memory system;
a switching circuit configured to transmit the input data or the sector data according to control of the address counter; and
a writing buffer configured to write data transmitted from the switching circuit to the memory system.

7. The display device of claim 6, wherein the data processor further includes a concatenator configured to combine the sector data in unit of sector extracted from the memory system and transmit the sector data to the reading buffer.

8. The display device of claim 6, wherein the address counter is configured to generate:
a global count indicating a number of sectors for processing data by comparing a start address and an end address of the input data;
a front count indicating a range between a starting point of the sector and the start address;
a rear count indicating a range between the end address and an end point of the sector; and
a write count indicating the second area.

9. The display device of claim 8, wherein the front count and the rear count indicate the first area.

10. The display device of claim 1, wherein the data processor is positioned within the timing controller.

11. A data processor incorporated to a memory system processing data in unit of sector, comprising:
a data input unit configured to receive an input data;
an address input unit configured to receive an address of the input data;
an address counter configured to determine a first area for maintaining sector data stored in the memory system and a second area for writing the input data in a sector using the address of the input data;
a reading buffer configured to transmit the sector data supplied from the memory system;
a switching circuit configured to transmit the input data or the sector data according to control of the address counter; and
a writing buffer configured to write data transmitted from the switching circuit to the memory system.

12. The data processor of claim 11, further includes a concatenator configured to combine the sector data in unit of sector extracted from the memory system and transmit the sector data to the reading buffer.

13. The data processor of claim 11, wherein the address counter generates:
a global count indicating a number of sectors for processing data by comparing a start address and an end address of the input data;
a front count indicating a range between a starting point of the sector and the start address;
a rear count indicating a range between the end address and an end point of the sector; and
a write count indicating the second area.

14. The data processor of claim 13, wherein the front count and the rear count indicate the first area.

15. A data processing method of a display device, comprising:
receiving input data and an address;
determining a location digit and a size digit of the address using sector information of a memory system;
extracting count information for processing data in unit of sector corresponding to the input data; and
processing data in unit of sector using the count information.

16. The data processing method of claim 15, wherein the address of the input data consists of 8 hexadecimal digits, the location digit is upper 5 digits of the 8 hexadecimal digits, and the size digit is lower 3 digits of the 8 hexadecimal digits.

17. The data processing method of claim 15, wherein the count information includes:
a global count indicating a number of sectors for processing data by comparing a start address and an end address of the input data;
a front count indicating a range between a starting point of a sector and the start address;
a rear count indicating a range between the end address and an end point of the sector; and
a write count indicating an area for writing the input data.

18. The data processing method of claim 17, wherein the front count and the rear count indicate an area for maintaining data in the sector.

19. The data processing method of claim 15, further comprising:
converting the address to binary number.
